(19) United States
(12) Patent Application Publication
(10) Pub. No.: US 2012/0227449 A1
(43) Pub. Date: Sep. 13, 2012

(54) STEERING WHEEL LOCK

(76) Inventor: CHEN-KUEI HSIEH, New Taipei City (TW)

(21) Appl. No.: 13/044,544

(22) Filed: Mar. 10, 2011

(51) Int. Cl. B60R 25/02; H04N 7/18

(52) U.S. Cl. 70/224; 348/148; 348/E07.085

(57) ABSTRACT

The steering wheel lock contains a main member having a clamp piece for fixedly locking the rim of a steering wheel, an alarm module housed in the main member and triggered if an abnormal situation is detected, a surveillance module that, when the alarm module is triggered, conducts video recording through a built-in digital camera, and a radio communication module housed in the main member which receives video signal from the surveillance module and transmits the video signal through a mobile communication network. When the alarm module is triggered, the surveillance module is then activated to start recording the interior of the motor vehicle. The car owner then could monitor what happens inside the motor vehicle and decide whether to take further action using a mobile communication device.

### (A) TECHNICAL FIELD OF THE INVENTION

The present invention is generally related to steering wheel locks, and more particularly to a steering wheel lock having a built-in video surveillance module capturing the images of the interior of a motor vehicle.

### (B) DESCRIPTION OF THE PRIOR ART

To prevent car theft, various devices such as steering wheel locks, gear locks, etc. are designed and manufactured. However, most of the time, the best of these locks is only to slow down the burglar and there is little effect in actually preventing the theft.

A type of locks that integrate wireless communication is therefore disclosed. The lock contains an alarm module that detects various abnormal situations such as change in air pressure, vibration, etc. After detecting the abnormality the lock transmits a message to notify the car owner about the abnormality so that the car owner could take further action.

This type of locks still suffers the following disadvantage.

There are various possible causes that could trigger the lock's alarm module but have nothing to do with theft. For example, the car is shook by another vehicle rushing close by, or the car owner's pets breaking into the car. The constant false alarms often wear the car owner down.

### SUMMARY OF THE INVENTION

Therefore, a novel steering wheel lock is provided herein where the images of the interior of a motor vehicle is captured and transmitted.

A major objective of the present invention is to have a video surveillance module conducting real-time video capture and a radio communication module to transmit the captured images over a mobile communication network.

To achieve the objective, the steering wheel lock contains a main member having a clamp piece for fixedly locking the rim of a steering wheel, an alarm module housed in the main member and triggered if an abnormal situation is detected, a surveillance module that, when the alarm module is triggered, conducts video recording through a built-in digital camera, and a radio communication module housed in the main member which receives video signal from the surveillance module and transmits the video signal through the mobile communication network.

The alarm module is capable of detecting abnormality such as the clamp piece is tampered with, or burglar intrusion by infrared or air pressure variation or vibration sensing or supersonic sensing. When a burglar breaks into the motor vehicle, the alarm module is able to detect the abnormality and thereby is triggered by the abnormality The surveillance module is then activated to start recording the interior of the motor vehicle. In the mean time, the radio communication module transmits the video signal through the mobile communication network to a mobile communication device having a display. The car owner therefore could monitor what happens inside the motor vehicle and decide whether to take further action.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a steering wheel lock according to an embodiment of the present invention.

FIG. 2 is a perspective schematic diagram showing the various components of the steering wheel lock of FIG. 1.

FIG. 3 is a schematic diagram showing the scenario of a burglar breaking into a motor vehicle configured with a steering wheel lock of the present invention.

FIG. 3A is an enlarged view of a portion of FIG. 3.

FIG. 4 is a schematic diagram showing an exemplary image captured by a surveillance module of the steering wheel lock of the present invention.

FIG. 5 is a schematic diagram showing a mobile communication device receiving and playing the image captured by a surveillance module of the steering wheel lock of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

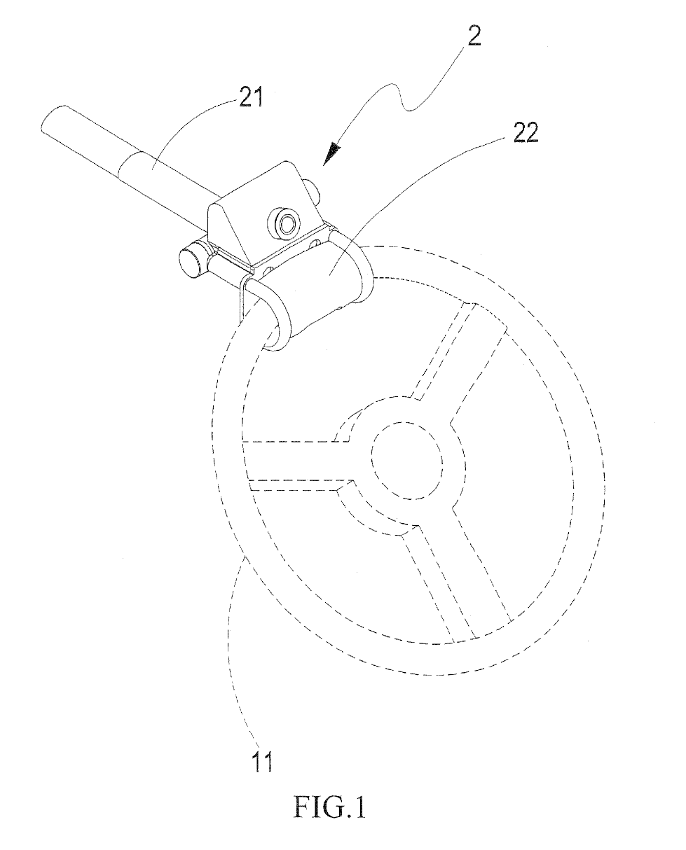

As shown in FIG. 1, a steering wheel lock 2 according to an embodiment of the present invention contains a main member 21 having a clamp piece 22 at a front end of the main member 21 for fixedly locking the rim of a steering wheel 11.

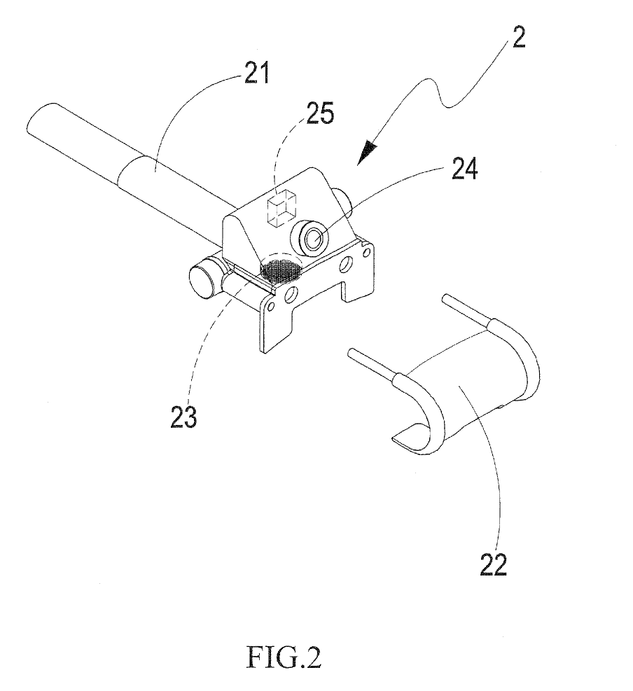

As shown in FIG. 2, the steering wheel lock 2 further contains an alarm module 23 which is housed in the main member 21 and is triggered if an abnormal situation is detected. The abnormal situation contains at least that the clamp piece 22 is tampered with.

The steering wheel lock 2 further contains a surveillance module 24 which, when the alarm module 23 is triggered, conducts video recording through a built-in digital camera.

The steering wheel lock 2 further contains a radio communication module 25 also housed in the main member 21 which receives video signal from the surveillance module 24 and transmits the video signal through a mobile communication network.

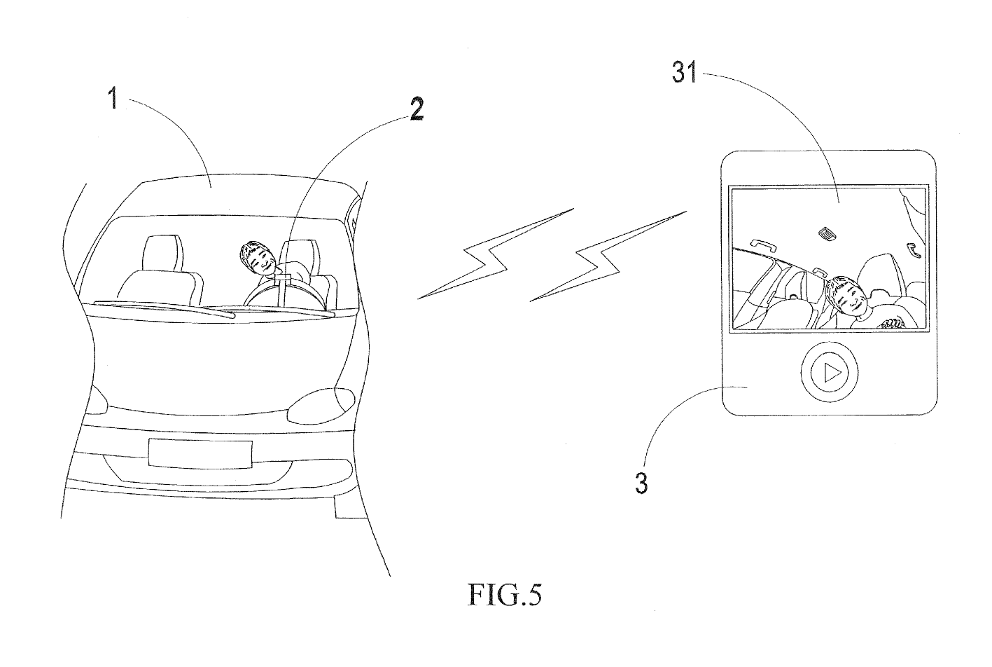

As shown in FIG. 5, a mobile communication device 3 having a display 31 is capable of receiving the video signal from the radio communication module 25 and presenting the video signal on the display 31.

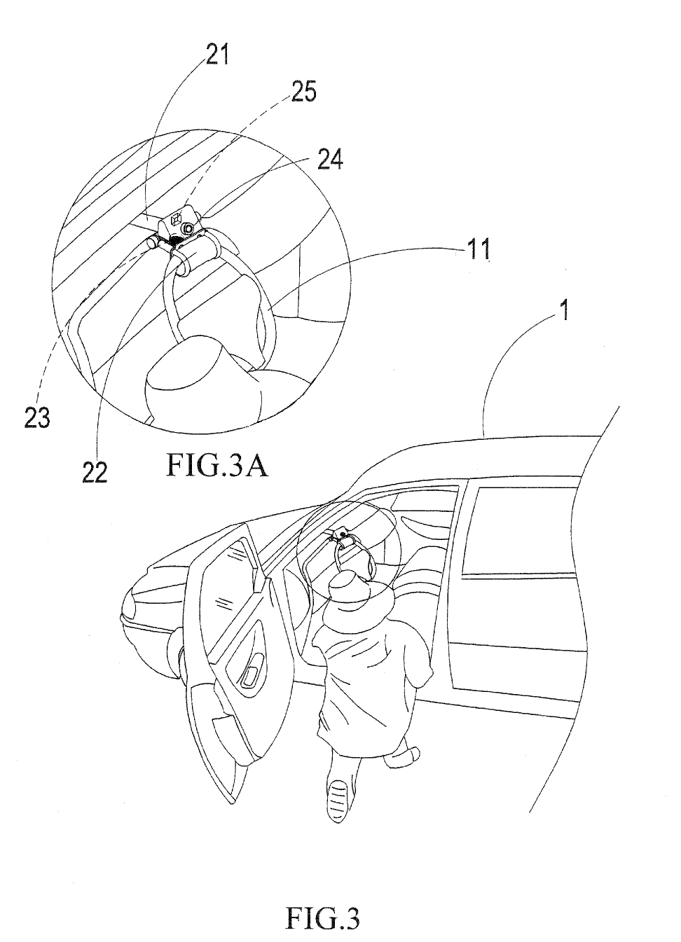

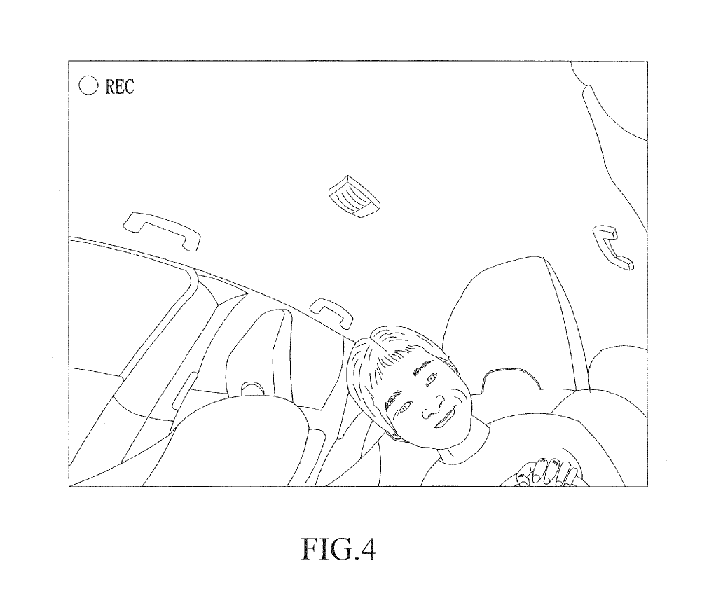

As described above, the steering wheel lock 2 could be easily and conveniently installed by fastening the clamp piece 22 of the main member 21 on the rim of the steering wheel 11. The alarm module 23 is capable of detecting abnormality such as intrusion by infrared or air pressure variation or vibration sensing or supersonic sensing. As shown in FIGS. 3 and 3A, when a burglar breaks into a motor vehicle 1 configured with a steering wheel lock 2 of the present invention, the alarm module 23 is able to detect the abnormality and thereby is triggered by the abnormality The surveillance module 24 is then activated to start recording. The video camera of the surveillance module 24 could be a wide-angled one so as to cover most of the interior of the motor vehicle 1, as illustrated in FIG. 4. In the mean time, the radio communication module 25 transmits the video signal through a mobile communication network.

As shown in FIG. 5, a mobile communication device 3 such as a cellular phone is able to receive and play the video signal on its display 31 in real time.

Compared to prior arts, the present invention's incorporation of video surveillance could greatly avoid false alarms resulted from scenarios such as the motor vehicle 1 is touched or shook, pets break into the motor vehicle 1, or even the driver mistakenly triggers the alarm module 23. When the alarm module 23 is triggered as such, a user is able to resolve the mistake by observing the real-time video capturing the interior of the motor vehicle 1.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A steering wheel lock for a motor vehicle, comprising:
a main member having a clamp piece for fixedly locking the rim of a steering wheel of said motor vehicle;
an alarm module housed in said main member and capable of detecting and being triggered by an abnormal situation, said abnormal situation including at least that said clamp piece is tampered with;
a surveillance module which, when said alarm module is triggered, conducting video recording of the interior of said motor vehicle; and
a radio communication module housed in said main member which receives a video signal from said surveillance module and transmits said video signal through a mobile communication network.

2. The steering wheel lock according to claim 1, wherein said video signal is received by a mobile communication device.

3. The steering wheel lock according to claim 2, wherein said video signal is played on a display of said mobile communication device.

4. The steering wheel lock according to claim 1, wherein surveillance module comprises at least a digital camera.
